(19) United States
(12) Patent Application Publication
(10) Pub. No.: US 2025/0136837 A1
(43) Pub. Date: May 1, 2025

(54) Exothermic Welding System

(71) Applicant: ERICO International Corporation, Solon, OH (US)

(72) Inventor: Nicholas Turner, North Royalton, OH (US)

(21) Appl. No.: 18/578,532

(22) PCT Filed: Jul. 17, 2023
(86) PCT No.: PCT/US2023/070299

§ 371 Date: Jan. 11, 2024

Related U.S. Application Data
(60) Provisional application No. 63/389,458, filed on Jul. 15, 2022.

(51) Int. Cl. C09D 161/04; B23K 23/00; B28B 1/00; B33Y 10/00; B33Y 30/00; B33Y 50/00; B33Y 80/00; C08K 3/04; C08K 3/36; C09D 7/61

(52) U.S. Cl. CPC C09D 161/04; B23K 23/00; B28B 1/001; B33Y 10/00; B33Y 30/00; B33Y 50/00; B33Y 80/00; C09D 7/61; C08K 3/04; C08K 3/36

(57) ABSTRACT

An exothermic welding container (100) can be formed, including as a single-use or other welding mold with a welding chamber (104) and crucible chamber (102). The welding container can be printed using additive manufacturing methods, including via binder jet printing with ceramic or other fines and a binder of furfuryl alcohol or phenolic materials. An additive manufacturing system can iteratively deposit and fuse layers of material (150A, 150B, 150C) to create a three-dimensional exothermic welding container in accordance with a digital model of the welding container.

### CROSS REFERENCE TO RELATED APPLICATIONS

This application claims priority to and incorporates by reference U.S. provisional patent application No. 63/389,458, filed Jul. 15, 2022.

### BACKGROUND

Exothermic welding can be used in different settings to form high quality, high ampacity, and low resistance electrical connections between different conductors. In general, an exothermic welding process can fuse together separate conductors to provide a bond with a current carrying capacity substantially equal to that of the conductors themselves. Further, exothermic welds can be relatively durable and long-lasting, and can avoid problems of loosening and corrosion that can occur for mechanical and compression joints. As a result of these benefits exothermic weld connections are widely used in grounding systems and other settings to enable connected sets of conductors to operate, effectively, as a continuous conductor with relatively low resistivity.

### SUMMARY

The present disclosure relates to exothermic welding and in particular to improved processes for forming exothermic welding containers.

Some examples of the present disclosure provide a method of producing an exothermic welding container. A digital model of an exothermic welding container can be provided to an additive manufacturing system. The exothermic welding container can be formed using the additive manufacturing system by, for a plurality of layers: depositing a layer of a base material with a shape based on the digital model; and fusing a portion of the base material in the shape provided by the layer to form a corresponding part of the exothermic welding container.

In some examples, the exothermic welding container can include a sidewall structure defining a welding chamber and a crucible chamber. The welding container can further include at least one channel that extends through the radial sidewall and into the welding chamber.

In some examples, fusing the portion of the base material can include spraying a binder onto the base material.

In some examples, the base material can be a silica sand. The base material can be fused using a binder that includes a furfuryl alcohol (e.g., wherein fusing the portion of the base material includes a polymerization reaction of the furfuryl alcohol with an acid applied to the base material).

In some examples, the base material can be a ceramic material.

In some examples, the base material can be fused using a binder that includes a phenolic binder.

In some examples, the base material can be a carbon-based material (e.g., including graphite fines).

In some examples, for each planar layer of the digital model, the additive manufacturing system can apply a binder to a plurality of regions of the base material to fuse layers for a plurality of exothermic welding containers.

In some examples, the exothermic welding container can be formed to include one or more level markers in a riser portion corresponding to one or more fill-levels for weld material.

In some examples, the exothermic welding container can be formed as a plurality of pieces with interlocking components.

Some examples of the present disclosure provide an exothermic welding container manufactured according to one or more of the operations described above. The exothermic welding container can be formed as an exothermic welding mold. The exothermic welding mold can include one or more of a crucible chamber to receive weld material, a welding container to receive conductors for welding with the weld material, and a tap hole extending between the crucible chamber and the welding chamber.

Some examples of the present disclosure provide a system for manufacturing an exothermic welding container, including a digital model that can include a three-dimensional representation of an exothermic welding container, a base material comprising loose fines, and an additive manufacturing system configured to apply binder to the base material. The additive manufacturing system can be configured to iteratively deposit a layer of the base material (e.g., into a job box), and apply the binder to the base material according to the digital model to cure the base material in a three-dimensional configuration corresponding to the three-dimensional representation of the exothermic welding container.

In some examples, the three-dimensional representation can include a radial sidewall defining a welding chamber and a crucible chamber. At least one channel can be defined in the sidewall, the at least one channel opening into and being continuous with the welding chamber to receive a conductor into the welding chamber.

In some examples, the loose fines can be ceramic fines.

In some examples, the loose fines can be graphite fines.

In some examples, a radial thickness of a radially peripheral wall in the digital model can be not constant along an internal chamber of the exothermic welding container.

In some examples, the binder can be a phenolic resin polymer.

### BRIEF DESCRIPTION OF THE DRAWINGS

The accompanying drawings, which are incorporated in and form a part of this specification, illustrate examples of the disclosed technology and, together with the description, serve to explain the principles of examples of the disclosed technology:

FIGS. 1 through 4 are isometric and elevation views of exothermic welding containers, rendered transparently to illustrate certain internal features;

FIGS. 5A-5D are perspective views of an exothermic welding system using the exothermic welding container of FIG. 3 in an exothermic welding process;

FIG. 6 is a flowchart illustrating a method for additively manufacturing an exothermic welding container according to some examples of the disclosed technology;

FIGS. 7A-7D are plan views of different layers generated from a digital model of the exothermic welding container of FIG. 3 according to some examples of the disclosed technology;

FIG. 8 is a plan view of a job box showing a plurality of layers of exothermic welding containers being concurrently printed according to some examples of the disclosed technology;

FIG. 9 illustrates a chemical reaction showing the polymerization of a furfuryl alcohol binder according to some examples of the disclosed technology.

### DETAILED DESCRIPTION

Before any examples of the disclosed technology are explained in detail, it is to be understood that the disclosed technology is not limited in its application to the details of construction and the arrangement of components set forth in the following description or illustrated in the following drawings. The disclosed technology is capable of other implementations and of being practiced or of being carried out in various ways. Also, it is to be understood that the phraseology and terminology used herein is for the purpose of description and should not be regarded as limiting.

The following discussion is presented to enable a person skilled in the art to make and use examples of the disclosed technology. Various modifications to the illustrated examples will be readily apparent to those skilled in the art, and the generic principles herein can be applied to other examples and applications without departing from the disclosed technology. Thus, the disclosed technology are not intended to be limited to examples shown, but are to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of examples of the disclosed technology. Skilled artisans will recognize the examples provided herein have many useful alternatives that also fall within the scope of the disclosed technology.

As noted above, exothermic welding can be used to connect metal structures, such as copper conductors of an electrical system. Generally, exothermic mixtures can include a combination of a reductant metal and a transition metal oxide, which react exothermically upon ignition to supply sufficient heat to propagate and sustain a continuing reaction of the mixture. The resulting heat can be used directly or the resulting molten metal can be used to create a useful weld, as in the case of exothermic welding.

As one example, some conventional exothermic weld material mixtures can include aluminum and copper oxide. Upon ignition, the resulting exothermic reaction can provide a mixture of molten copper and aluminum oxide (the latter being commonly referred to as “slag”). The molten copper has a higher density than the slag and can accordingly be caused by gravity to flow within a mold to weld together metal conductors (e.g., copper to copper or steel to steel). The less dense aluminum oxide slag is generally removed from the weld connection, or from other parts of the mold in which it may accumulate, and is discarded. As another example, other conventional mixtures can include iron oxide and aluminum, which can react with similar effect.

Exothermic mixtures of this type do not react spontaneously and need a method of initiating the reaction, which involves generating enough localized energy to enable the exothermic reaction to begin. One typical method of initiating ignition is through use of starting powder and an ignition source such as an electric igniter or a flint igniter.

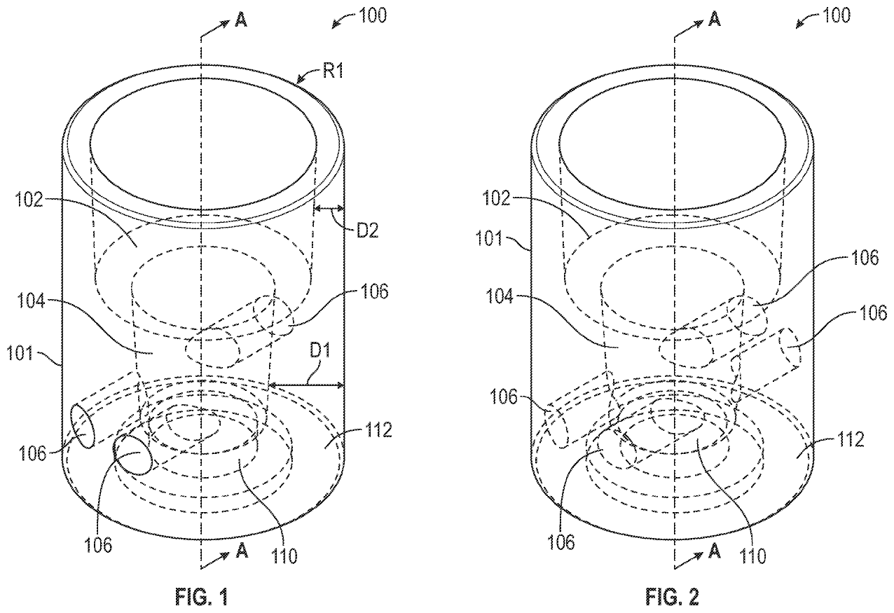

Exothermic welding containers (e.g., molds) can be provided to contain exothermic reactions, and to weld conductors in a desired configuration. For example, FIG. 1 illustrates an exemplary exothermic welding container 100, having a radial sidewall 101 (e.g., as can be manufactured using the methods detailed below). As shown, the exothermic welding container 100 can be generally tubular having an outer radius R1 and defining internal regions for containing the exothermic reaction and forming the weld. Although the example mold exhibits radial symmetry and generally circular cross-sectional profiles, other types of sidewall structures are possible in other examples.

In some examples, a crucible chamber 102 can be provided in an upper portion of the exothermic container 100, and a welding chamber 104 can be defined in a lower portion of the container 100. The welding chamber 104 and the crucible chamber 102 can have different volumes that can in some cases correspond to a thickness of the radial sidewall 101. For example, as shown in FIG. 1, the radial sidewall 101 can have a thickness D1 along the welding chamber 104, and a thickness D2 along the crucible chamber 102. The thickness D1 can be greater than D2, and can generally determine a molded shape for a resulting weld while also providing thermal conditions advantageous for creating a quality weld in the welding chamber 104. In some examples, a thickness of the radial sidewall 101 can vary along a radial or along an axial dimension, which can produce thermal conditions for exothermic welding containers of different configuration to produce quality welds.

To accommodate conductors (to be welded), channels 106 can be provided in the radial sidewall 101 of the container 100. The channels 106 can extend radially through the sidewall 101, transverse to a radial axis A of the container 100, and can further open into, and be continuous with, the welding chamber 104. Conductors (e.g., steel wires, copper wires, etc.) can be inserted through the channels 106 into the welding chamber 104, and can thus, for example, be positioned to be welded together with other conductors that are inserted through other channels 106 into the weld chamber 104.

In some cases, a welding container can define an opening for a ground rod, to facilitate the exothermic welding of conductors to the ground rod. For example, in FIG. 1, an opening 110 is defined in a bottom surface 112 of the container 100, into which a ground rod can be received. As shown, the opening 110 can be coaxial with the crucible chamber 102 and the welding chamber 104, and can be positioned beneath and open into the welding chamber 104. The illustrated container 100 shows three channels 106 and one opening 110 for a ground rod, and an exothermic weld performed in the container can thus weld three conductors to a ground rod. However, other configurations are possible, including as illustrated in FIG. 2, which shows an exothermic welding container 100 that is generally similar to the exothermic welding container 100 of FIG. 1, but includes four channels 106 for receiving conductors, the channels being positioned on opposite sides of the radial sidewall 101.

In other configurations, an exothermic welding container could have any number of channels, as may correspond to the particular welded configuration to be obtained. Further, one or more channels of an exothermic welding container can be differently positioned than those illustrated in FIGS. 1 and 2. In some cases, for example, some channels be positioned at right angles relative to other channels, or could be offset from other channels in a direction parallel to an elongate axis A of a mold (or other reference line). Further, an exothermic welding container may not include an opening for a ground rod, and could instead be configured only for welding conductors together through one or more the channels in the side wall.

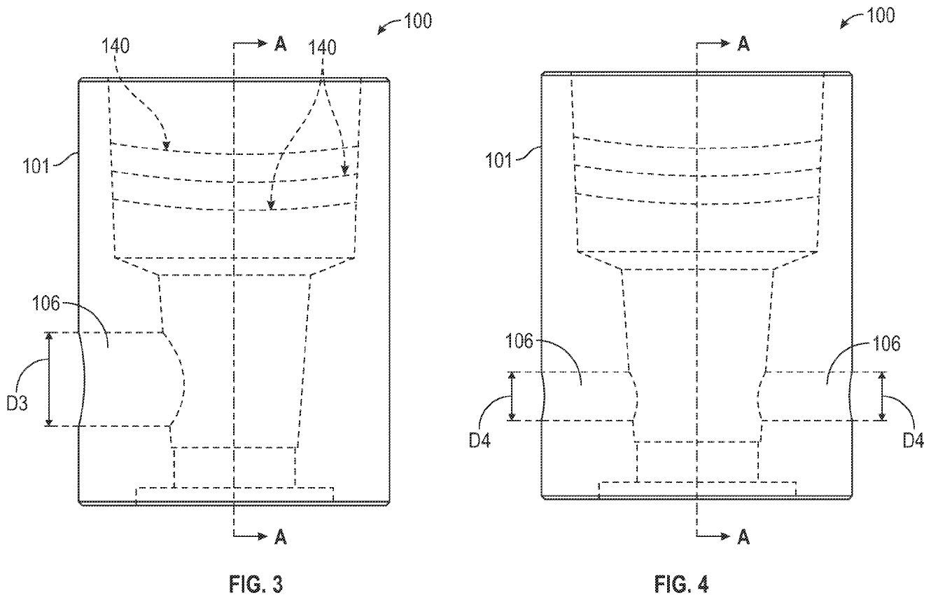

Exothermic welding containers can additionally be configured to accommodate conductors of differing widths. For example, FIGS. 3 and 4 illustrate exothermic welding containers 100 with channels 106 of differing widths. In particular, in the illustrated example, the channel 106 of FIG. 3 has a width D3 that is larger than the width D4 of the channels 106 of the exothermic welding container 100 shown in FIG. 4. However, other configurations are possible in other examples. Indeed, in this regard, electrical connections may require that any number of different conductors, of a variety of different diameters, be welded together or welded to a ground rod in a variety of different positions. It may thus be useful to provide exothermic welding containers for a wide variety of different welding configurations, including, for example, the configurations illustrated in FIGS. 1-4 and various others. However, conventional methods of producing exothermic welding containers may include a significant cost for manufacturing exothermic welding containers having different configurations, and it may therefore be impractical or cost-prohibitive to produce exothermic welding containers for some applications using conventional methods.

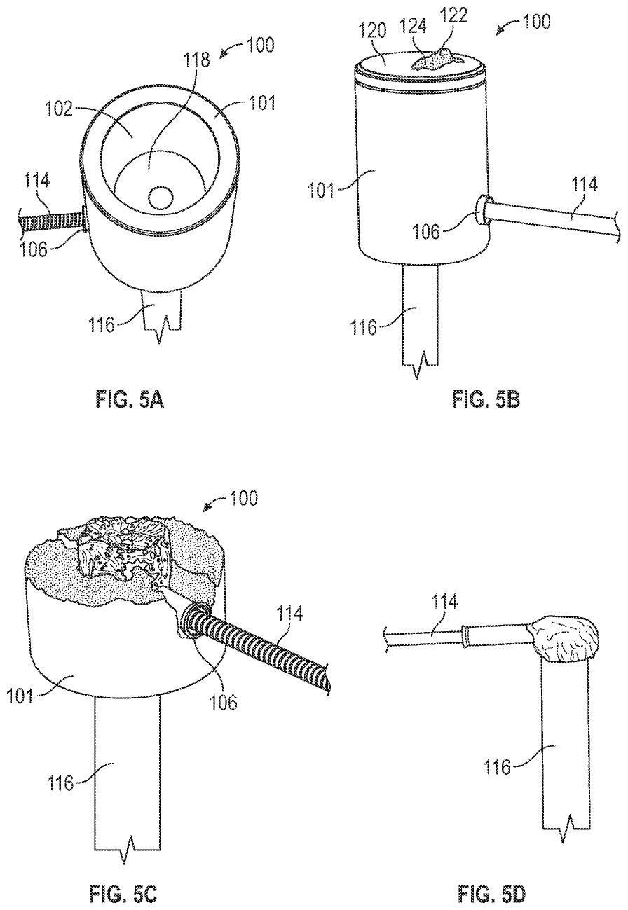

FIGS. 5A-5D illustrate a conventional exothermic welding process using an example conventional configuration of the exothermic welding container 100 (e.g., similar to as shown in FIG. 3). In some cases, conventional exothermic welding containers can be single-use molds, which can be removed from the welded connection by breaking the mold after the exothermic welding reaction. As shown in FIG. 5A, a conductor 114 can be inserted into the channel 106, and a ground rod 116 can be inserted into the corresponding opening 110 (not shown in FIGS. 5A-5D) of the container 100. FIG. 5A illustrates a crucible chamber 102 of the container, with a plate 118 separating the crucible chamber 102 from the welding chamber 104 (not shown in FIGS. 5A-5D). The crucible chamber can be filled with weld material and, as shown in FIG. 5B, a lid 120 may be placed over the crucible chamber 102 to prevent the escape of particulate matter from the container 100 during the exothermic reaction. Starting material 122 may be added through an aperture 124 of the lid 120, and along a top surface of the lid 120, and can be ignited to initiate the exothermic reaction.

As discussed above, during the reaction, the weld material is changed to molten metal. The heat from the reaction melts the plate 118, and the force of gravity causes the molten metal to flow into the welding chamber 104 to join the ground rod 116 to the conductor 114. Once the weld has been completed, the mold may be broken off the welded connection and the connection cleaned or otherwise processed as appropriate. In this respect, FIG. 5C illustrates the exothermic welding container 100 partially broken off of a welded connection of the ground rod 116 and the conductor 114, with only a lower portion of the exothermic welding container 100 remaining. FIG. 5D then illustrates the resultant welded connection of conductor 114 and ground rod 116, with the mold 100 completely removed (e.g., broken free and discarded).

Conventional exothermic welding containers, including a single-use mold (e.g., as illustrated in FIGS. 5A-5C), can be manufactured using conventional subtractive manufacturing methods. Some conventional methods for manufacturing exothermic welding containers can utilize manufacturing molds (e.g., cordierite molds) into which the material for the exothermic welding containers can be press-fit. The molds can generally define an inverse of the shape of the exothermic welding container, with different molds being required to produce exothermic welding containers of different shapes or configurations. Thus, for example, in some conventional methods, producing an exothermic welding container having different dimensions (e.g., a different external radius, different thicknesses of the radial wall, etc.) necessitates the use of a different manufacturing mold. Similarly, a difference in a thickness of a peripheral wall may also require the use of a different mold. Correspondingly, conventional systems may exhibit relatively high cost for producing exothermic welding containers of different configurations, as any change in dimensions of an exothermic welding container may require the production of new tooling to manufacture the container. There is therefore a need in the art for a method of producing a wide range of configurations of exothermic welding containers, including as may not incur substantial additional tooling costs.

Conventional methods may also impose undesirable limitations on the materials that may be used to produce exothermic welding containers. For example, conventional exothermic welding containers may be manufactured by molding or machining a ceramic material. Such an approach may provide a heat-resistant container for containing an exothermic reaction, but the container may be unusable after a single reaction (i.e., may be a single-use container). It may therefore be desirable to use manufacturing methods by which different materials could economically be utilized to produce exothermic welding containers, including containers that could be used more than once.

It may also be desirable to use materials having different properties, which could, for example, facilitate the production of molds that could accommodate weld configurations with different thermal profiles. For example, thermal profiles within a welding chamber of a conventional exothermic welding container may not be conducive to certain welding configurations and could produce a lower-quality weld in those configurations. Adjustments may be required to the dimensions of an exothermic welding container to make a container suitable for producing high-quality welds given different welding configurations, or different materials. As an example, a different thickness may be required in a section of the radial wall to generate a heat profile that is suitable for a given welding configuration. The required thickness or dimensions of a weld chamber of an exothermic welding container may differ based on the material used to produce the mold.

In this light, conventional manufacturing methods impose practical limitations on materials that may be used in producing exothermic welding containers, or on dimensional adjustments that may be necessary to accommodate differently configured welds. In particular, each dimensional variation would require the creation of a new manufacturing mold for the new configuration, which may not be economically practical or otherwise workable.

Conventional methods for manufacturing exothermic welding containers can further impose manufacturing costs for producing different configurations of containers, even where the different configurations do not require the use of new molds or tooling to produce. For example, in some conventional methods, channels in a peripheral wall of the container for receiving conduit (e.g., channels 106) can be produced through subtractive manufacturing methods (e.g., drilling). This can impose additional material costs by requiring the container to first be produced with extraneous material that will then be removed to generate the desired configuration. Further, the described conventional method may impose still more manufacturing costs by requiring an additional precise rotation of a container during the manufacturing process to correctly position the container for drilling an additional channel.

Producing channels of different diameters may also impose additional manufacturing costs by introducing the need to use additional tooling to drill a channel of the requisite diameter, which can also necessitate further rotation of the mold during manufacturing. This additional manipulation of the container during manufacturing, as well as the drilling required may produce defects in some containers due to variation in alignment, for example. There is thus a need in the art for a method of manufacturing exothermic welding containers that allows different configurations of a container to be manufactured without the need for additional tooling, and further allows containers to be manufactured in a manner that does not require subtractive manufacturing methods, which can impose additional material costs and introduce error and defects in the manufacturing process.

To address these and other difficulties inherent in conventional systems, improved methods for manufacturing an exothermic welding container can be provided. According to some examples, methods (and related systems) can be provided for manufacturing an exothermic welding container, including methods to additively manufacture an exothermic welding container based on a digital model that includes a three-dimensional representation of an exothermic welding container. In some examples, such production can result in an exothermic welding container that is usable as-is, although other examples may require or benefit from various post-machining processes (e.g., smoothing, boring, grinding, etc.)

A variety of additive manufacturing systems are generally known in the art, with some examples configured in particular as binder jet systems. Binder jet systems typically include a nozzle or other assembly to deposit binder, and sub-systems of various known types to add to or remove from a containing vessel (herein, a “job box”) base material that includes loose powder of various types (e.g., for exothermic welding containers, a silica sand, ceramic fines, or graphite or other carbon fines). These systems can accordingly operate by systematically depositing a base material containing loose powder into a job box, and selectively applying a binder (e.g., an adhesive) to the base material in accordance with the digital model (i.e., with the binder being deposited in a pattern corresponding to the solid form of the corresponding layer of the product being manufactured). Thus, the deposited binder can cure the base material together, where applied, to produce a corresponding solid layer of the relevant product (e.g., exothermic welding container). This process can then be repeated for a number of layers, until the relevant product (e.g., exothermic welding container) has been produced, corresponding to the three-dimensional representation of the digital model.

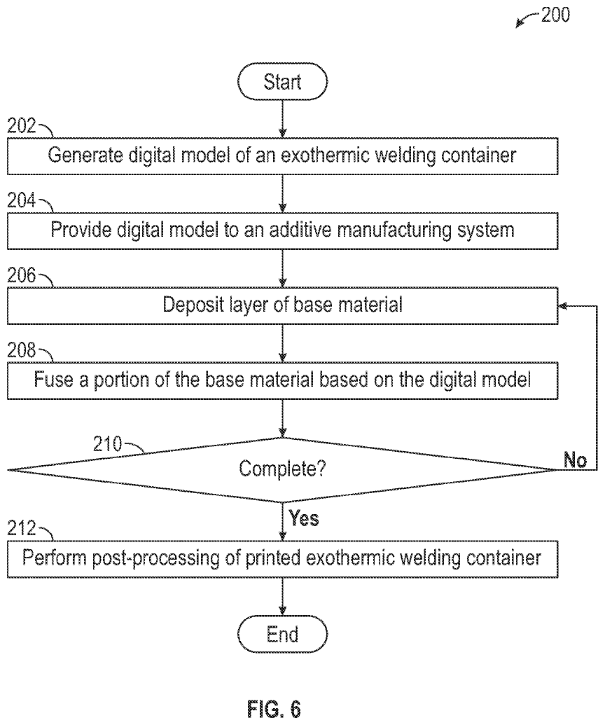

In this regard, FIG. 6 illustrates an exemplary process 200 for manufacturing an exothermic welding container which can mitigate (e.g., eliminate) the above-mentioned problems with conventional manufacturing methods. The process 200 can be a binder jet printing process, which can provide a benefit in allowing for simultaneous printing of a production volume of exothermic welding containers. In other examples, other printing method can be used, including but not limited to fused filament fabrication (FFF), Fused Granulate Fabrication (FGF), direct ink writing (DIW), electrospark deposition (ESD), and directed energy deposition (DED) using laser, plasma, arc, plasma transferred arc, electron beam, or exothermic reaction as heat sources, and ink, filament, pellets, powder, or wire as feedstocks.

As illustrated, at operation 202, a computer model of an exothermic welding container can be generated. This computer model may include a three-dimensional digital representation of an exothermic welding container, including dimensions and configurations of the exothermic welding container, e.g., a thickness of a peripheral wall, a number, dimension, and orientation of conductor or other channels, an orientation, size, and shape of a tap hole or rise, a shape and size of a welding or crucible chamber, a dimension of a ground rod opening, etc. In some examples, the model can include digital representations of any of the containers 100 illustrated in FIGS. 1-4. In other examples, the digital model can include a digital representation of containers of other configurations, including, for example welding configurations with more than the four channels 106 or with the channels 106 being oriented at different radial (or other) angles with respect to each other, or configurations without a ground rod aperture.

In some cases, the digital model can include digital representations of containers with geometries that may allow the container to be removed from a welded connection without the need to break the container off of the connection, as shown, for example, in FIG. 5C. For example, the exothermic welding container could be printed in two halves that can be temporarily joined during a welding operation with the use of clamps, fasteners, or any other method known in the art for temporarily securing one component to another. In some cases, digital models (and the resulting molds) can include multiple pieces with interlocking components (e.g., press-fit or bayonet-engagement features) that can be used to secure the pieces together for welding operations.

In some cases, models can include different features or dimensions based on the material to be used to produce the container. In some examples, a thickness of the weld chamber can be adjusted in a digital model to produce a thermal profile in a weld chamber that can produce a high-quality weld given the material used to produce the container.

At operation 204, the digital model can be provided to an additive manufacturing system (e.g., of the various types noted above), which can translate the model into instructions for producing the exothermic welding container. For example, an additive manufacturing system may convert a digital model of a three-dimensional exothermic welding container into a number of layers that may be successively printed to produce the exothermic welding container. In some cases, a digital model can be created using an additive manufacturing system. In some cases, a digital model can be pre-made and a relevant method can include simply using—e.g., rather than necessarily generating—the pre-made model in combination with an additive manufacturing system.

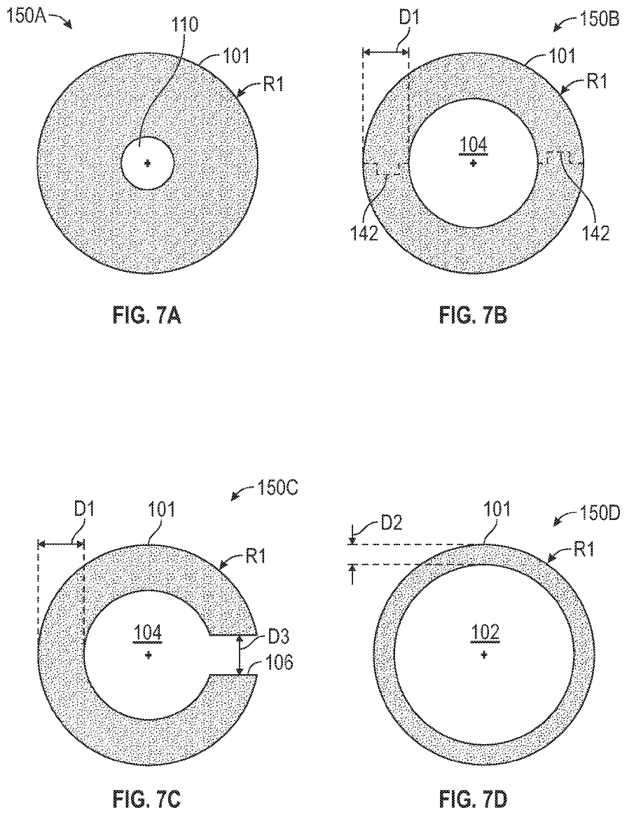

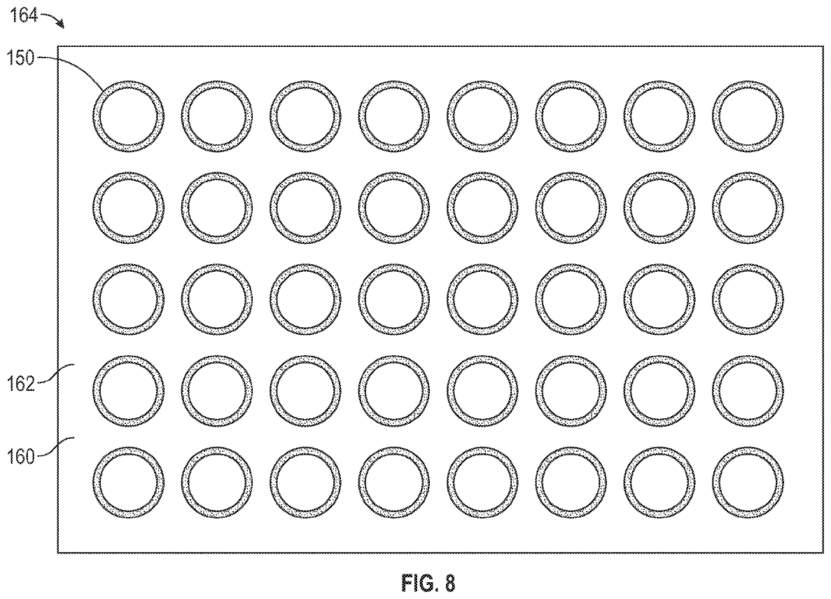

Further regarding the layers noted above, FIGS. 7A-7D illustrate exemplary planar layers 150 of a digital model for an exothermic welding container (e.g., exothermic welding container 100). For example, FIG. 7A shows a planar layer 150A of the digital model. In particular, the planar layer 150A can be a layer that includes the opening 110 for the ground rod, defined in the bottom surface 112. FIG. 7B illustrates a planar layer 150B, which, as shown, is a layer of the exothermic welding container 100 along the weld chamber 104 (and can correspondingly be deposited above—and, e.g., after—the layer 150A). In layer 150B, the radial wall 101 thus has the thickness D1. FIG. 7C illustrates another planar layer 150C which is another layer of the weld chamber but further includes a portion of the channel 106, having the diameter D3 (e.g., as shown in FIG. 3). FIG. 7D illustrates planar layer 150D which is a planar layer of the crucible chamber 102, with the radial wall 101 having the thickness D2.

Referring back to FIG. 6, at operation 206, the additive manufacturing system can deposit a level of base material for the exothermic welding container. In particular, the material deposited by the additive manufacturing system can include a material of which the exothermic welding container will ultimately be composed (e.g., in addition to a binder or other material that may not be preserved in the final mold).

In some examples, the deposited material can be a silica sand, e.g., with the silica sand evenly deposited along a planar surface of a relevant layer. In some examples, the deposited material can be a carbon material (e.g., graphite) or can be a ceramic material (e.g., semi-crystalline alumina silicate, sintered bauxite, etc.). Powder used as a base material for an additive manufacturing system can alternatively be referred to as “fines,” and base material can thus include, for example, graphite fines, ceramic fines, aluminum fines, etc. In some examples, the use of ceramic fines can provide an exothermic welding container of particular resilience and overall strength. In some examples, the use of a carbon-based material (e.g., graphite fines) can enhance a heat resistance of the exothermic welding container, and can more readily allow for the manufacturing of multi-use exothermic welding containers. In some examples, it may be beneficial to use fines (e.g., graphite fines) with an average particle size of 100 fineness, as specified by the Fineness Number system of the American Foundry Society.

The layers of the digital model can be used as instructions for the additive manufacturing system to produce an exothermic welding container. For example, at operation 208, a portion of the base material can be fused, in accordance with the instructions generated for the digital model. For example, for a given layer of base material, a binder can be applied to a portion of the layer to fuse a portion of the base material together, which can produce at least a portion of the exothermic welding container. In some examples, the binder can be applied in a planar layer having one of the profiles shown in FIGS. 7A-7D. In any case, the portion of the powder to which the binder is applied can generally then be cured to form a solid portion of the exothermic welding container.

In some examples, as shown in FIG. 8, a base material 160 can be deposited on a planar surface 162 of a job box 164 (or other workspace), having a length and width that can accommodate the simultaneous manufacturing of multiple exothermic welding containers 100. As illustrated, for example, a binder can be applied to the base material 160 to fuse a planar layer 150 of the base material 160 for a plurality of exothermic welding containers 100 along the planar surface 162. In this regard, the job box 164 can have a depth that is equal to or greater than a height of the exothermic welding container 100, to allow for base material 160 to be deposited at a sufficient depth to produce the exothermic welding container 100. After the first layer of base material 160 has been deposited onto the planar surface 162, the next layer of base material 160 can be deposited on the previously deposited base material 160, which can comprise a planar surface parallel to the planar surface 162.

In this regard, referring back to FIG. 6, at operation 210, the process 200 can check a completion of the additive manufacturing process for the exothermic welding container or plurality of exothermic welding containers 100. For example, printing the exothermic welding container 100 can require iteratively depositing and fusing the base material, and the number of iterations can correlate to the number of layers into which the digital model is divided in operation 204. At operation 210, then, the additive manufacturing system can check if the number of iterations of depositing and fusing is equivalent to the number of planar layers of the exothermic welding container (or otherwise determine whether all layers have been created). If the system has not performed a deposit and fusing (or other relevant operation) for each layer, the system can repeat operations 206 and 208 until a depositing and fusing operation has been performed for each layer. Upon completion of the printing operations, as desired, the resultant printed exothermic welding container or containers 100 can thus be substantially identical to the three-dimensional representation provided in the digital model at operation 202.

In some examples, a binder for an additively manufactured mold can be a furan resin material (e.g., furfuryl alcohol). In this case (or others), when constructing the exothermic welding container, the base material can be coated with an activator. In some examples, the activator can be an acid. To fuse the layers 150 of the exothermic welding container 100, or plurality of exothermic welding containers 100 (e.g., as shown in FIG. 8), a component of the binder can be added (e.g., sprayed) onto the base material coated in the activator. For example, as noted above, the added binder component can be a furfuryl alcohol. When the furfuryl alcohol (or other binder component) contacts the activator, this can initiate a chemical reaction to produce a suitably bonded mold body.

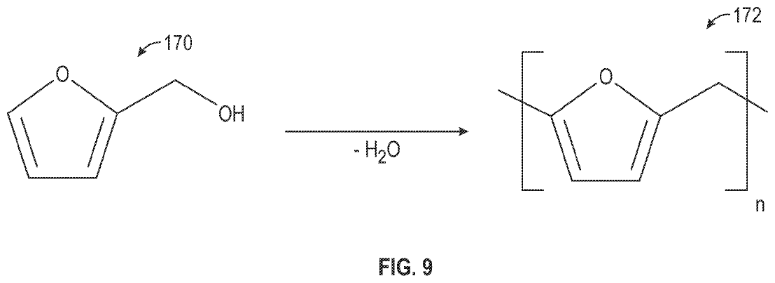

An example reaction for curing a suitable binder is illustrated in FIG. 9. As shown, the reaction can be a polycondensation reaction of a furfuryl alcohol 170. When the activator comes in contact with the binder (e.g., when the furfuryl alcohol is sprayed onto the base material), a polycondensation reaction shown in FIG. 9 proceeds. In the above example of the polycondensation of furfuryl alcohol, the hydroxide (OH) functional group leaves the furfuryl alcohol molecule due to the proton donation of the acid activator catalyst. The resulting methylfuran monomers 172 are then able to polymerize and form a long chain polymer with the formation of water as a byproduct. The polymerization fuses the sprayed portion of the base material 160, forming a solid portion of the base material 160 that constitutes a part of an exothermic welding container 100.

In some cases, using a base material of silica sand with a furan resin binder, as described, can be advantageous, as it can chemically cure the portions of the exothermic welding container without the need for post processing heat treatment. This approach can thus further reduce a cost of producing exothermic welding containers. In other examples, however, a base material and binder or adhesive used to additively manufacture an exothermic welding container can require additional heat treatment to cure the printed container after the container is printed. Similarly, although particular chemicals and deposition techniques are described in the examples above, other examples can include other chemicals or utilize other processes to additively manufacture a mold.

In this regard, for example, the binder for an additively manufactured mold can be a phenolic resin polymer, which may be substituted for the furan resin material in the process above, or could react with other activators (or with no activators) to bind portions of the base material together. In particular, a phenol formaldehyde resin (or, herein, simply “phenol resin”) can be formed as a thermosetting polymer that can be cured simply by the application of sufficient heat energy. Correspondingly, for example, manufacture of an exothermic welding container with phenol resin can be accomplished without applying a catalyst or other additional material to any particular layer, once the resin binder is deposited onto the base material in a relevant pattern for any given layer. In some examples, phenol resin binder can be used with silica base material, which can provide improved resilience relative to the heat of a welding process than a similar configuration using furfuryl alcohol and an activator. In some example, phenol resin binder can be used with ceramic or carbon-based (e.g., graphite) fines.

Referring again to FIG. 6, once the additive manufacturing operation has completed, post-processing activities can be performed (as operation 212) on the printed exothermic welding containers. For example, over the course of printing, a job box containing the printed exothermic welding containers 100 may also be filled with unfused base material that was deposited in operation 206. The unused based material may need to be drained from the job box so that the printed exothermic welding containers 100 can be removed from the job box, or, alternatively, the printed containers 100 can be removed directly. Other post-processing operations may also be used in some cases, including operations to remove base material residue from the printed containers 100. In some examples, further treatment, including heat treatment or application of a coating to the printed containers 100 may be completed before the exothermic welding containers 100 are used for welding connections.

In some examples, additive manufacturing processes (e.g., as described above) can be used to introduce other features into a mold for exothermic welding. In some cases, a portion of a mold can be formed to include demarcations that can assist users in appropriately filling or assessing a fill-level of the mold for welding operations. For example, fill lines 140 can be formed in a riser portion of a mold as shown in FIG. 3, or at other locations. As another example, as also noted above, interlocking features (e.g., interlocking protrusions) can be formed into different parts of a mold, and can thereafter be used to join the parts together for welding operations. For example, keyed interlocking features 142 can be provided, as shown in FIG. 7B (e.g., for press-fit inter-engagement). As another example, any one or more of a filter structure for a welding container can be formed by additive manufacturing, as can attachment features for handles, clamps, separate crucibles, etc.

Thus, examples of the disclosed technology can provide substantially improved manufacturing methods for exothermic welding systems. For example, using the manufacturing method disclosed, exothermic welding containers can economically be produced for multiple welding configurations without the need for specialized tooling or processing for each configuration, and the attendant cost. Additionally, the disclosed methods can allow for dimensions of an exothermic welding container to be varied at little cost, to thereby economically produce a thermal profile appropriate for a variety of different materials and configurations, and can allow for the manufacturing of exothermic welding containers using a variety of materials with corresponding benefits (e.g., for multiple-use graphite containers, rather than conventional single-use containers).

The use herein of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Also as used herein, unless otherwise limited or specified, “substantially identical” refers to two or more components or systems that are manufactured according to the same process and specification, with variation between the components or systems that are within the limitations of acceptable tolerances for the relevant process or specification. For example, two components can be considered to be substantially identical if the components are manufactured according to the same standardized manufacturing steps, with the same materials, and within the same acceptable dimensional tolerances (e.g., as specified for a particular process or product).

The previous description of the disclosed examples is provided to enable any person skilled in the art to make or use the disclosed technology. Various modifications to these examples will be readily apparent to those skilled in the art, and the generic principles defined herein may be applied to other examples without departing from the spirit or scope of the disclosed technology. Thus, the disclosed technology is not intended to be limited to the examples shown herein but is to be accorded the widest scope consistent with the principles and novel features disclosed herein.

1-15. (canceled)

16. A method of producing exothermic welding systems, the method comprising:
providing a digital model of an exothermic welding container to an additive manufacturing system;
forming the exothermic welding container using the additive manufacturing system by, for a plurality of layers:
depositing a layer of a base material with a shape based on the digital model; and
fusing a portion of the base material in the shape provided by the layer to form a corresponding part of the exothermic welding container.

17. The method of claim 16, wherein the exothermic welding container includes a sidewall structure defining a welding chamber and a crucible chamber, and wherein the exothermic welding container further includes at least one channel that extends through the sidewall structure and into the welding chamber.

18. The method of claim 16, wherein the base material is a silica sand;
wherein the base material is fused using a binder that includes a furfuryl alcohol; and
wherein fusing the portion of the base material includes a polymerization reaction of the furfuryl alcohol with an acid applied to the base material.

19. The method of claim 16, wherein the base material is a ceramic material, and wherein the base material is fused using a binder that includes a phenolic binder.

20. The method of claim 16, wherein the base material is a carbon-based material, including graphite fines; and
wherein fusing the portion of the base material includes spraying a binder onto the base material.

21. The method of claim 16, wherein for each planar layer of the digital model, the additive manufacturing system applies a binder to a plurality of regions of the base material to fuse layers for a plurality of exothermic welding containers.

22. The method of claim 16, wherein the exothermic welding container is formed to include one or more level markers in a riser portion corresponding to one or more fill-levels for weld material.

23. The method of claim 16, wherein the exothermic welding container is formed as a plurality of interlocking pieces.

24. A manufacturing system comprising:
a digital model including a three-dimensional representation of an exothermic welding container;
a base material comprising loose fines; and
an additive manufacturing system configured to apply binder to the base material;
wherein the additive manufacturing system is configured to iteratively deposit a layer of the base material and apply the binder to the base material according to the digital model to cure the base material into a three-dimensional configuration corresponding to the three-dimensional representation of the exothermic welding container.

25. The manufacturing system of claim 24, wherein the three-dimensional representation includes a radial sidewall defining a welding chamber and a crucible chamber, and wherein at least one channel is defined in the radial sidewall, the at least one channel opening into and being continuous with the welding chamber to receive a conductor into the welding chamber.

26. The manufacturing system of claim 24, wherein the loose fines are ceramic fines.

27. The manufacturing system of claim 24, wherein the loose fines are graphite fines.

28. The manufacturing system of claim 24, wherein a radial thickness of a radially peripheral wall in the digital model is not constant along an internal chamber of the exothermic welding container.

29. The manufacturing system of claim 24, wherein the binder is a phenolic resin polymer.

30. An exothermic welding container comprising:
a sidewall structure formed of a base material fused with a binder;
the sidewall structure defining:
a welding chamber that includes a first cavity to receive conductors;
a crucible chamber that includes a second cavity to receive weld material;
a tap hole extending between the crucible chamber and the welding chamber; and
at least one channel that extends through the sidewall structure and into the welding chamber.

31. The exothermic welding container of claim 30, wherein the base material includes a silica sand and the binder includes a furfuryl alcohol.

32. The exothermic welding container of claim 30, wherein the base material includes a ceramic material and the binder includes a phenolic binder.

33. The exothermic welding container of claim 30, wherein the sidewall structure integrally include one or more level markers corresponding to one or more fill-levels for weld material.

34. The exothermic welding container of claim 33, wherein the one or more level markers are arranged along a riser portion of the sidewall structure.

35. The exothermic welding container of claim 30, wherein a radial thickness of a peripheral wall of the sidewall structure is not constant along one or more of the first cavity or the second cavity.
